(19) United States
(12) Patent Application Publication
(10) Pub. No.: US 2009/0182090 A1
(43) Pub. Date: Jul. 16, 2009

(54) USE OF CARBOXYL-FUNCTIONAL POLYVINYL ACETATES FOR PRODUCING BMC PARTS

(75) Inventor: René Graewe, Landshut (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/297,767

(22) PCT Filed: Apr. 18, 2007
(86) PCT No.: PCT/EP2007/053746

§ 371 Date: Oct. 20, 2008

(30) Foreign Application Priority Data
Apr. 27, 2006 (DE) 10 2006 019 686.4

(51) Int. Cl. C08L 31/04; C08G 63/91

(52) U.S. Cl. 524/563; 525/55

(57) ABSTRACT

BMC molding compositions containing carboxy-functional polyvinyl acetate resins having minimally 3 weight percent of carboxy-functional monomers exhibit only modest increase in viscosity upon addition of fillers as compared to similar compositions employing polyvinyl acetate homopolymers.

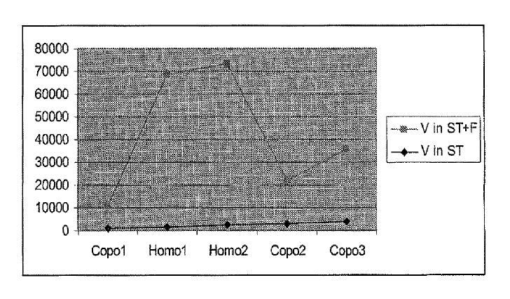

The invention relates to the use of solid carboxy-functional polyvinyl acetate resins for the production of BMC moldings.

Production of sheet-like plastics parts often uses unsaturated polyester resin compositions (UP resins). These polyester resins are reaction products of a dicarboxylic acid or of a dicarboxylic anhydride with a polyol. These polyester resin compositions also comprise a monomer having ethylenically unsaturated groups, generally styrene. Styrene is added to the polyester resin composition in order to dissolve the polyester and to ensure that the polyester composition is flowable. For reinforcement of the plastics parts obtained using the polyester resin composition, the polyester resin compositions also comprise fiber materials, such as glass fiber, carbon fiber, or corresponding fiber mats.

A problem in the processing of these polyester resin compositions (Fiber Reinforced Plastic composites=FPR composites) is volume shrinkage during the heat-curing of the polyester resin. In order to reduce shrinkage during the hardening of the polyester resin, therefore, “low-profile additives” are added to the same. The low-profile additive reduces shrinkage during hardening, relieves internal stresses, reduces microcracking, and makes it easier to comply with manufacturing tolerances. The low-profile additives are thermoplastics, such as polystyrene, polymethyl methacrylate, and in particular polyvinyl acetate. Polyvinyl acetates having up to 1% by weight of carboxy-functional comonomer units are also used. At higher content of carboxy-functional comonomer units, shrinkage reduction is not satisfactory.

Two processes for the production of thermoset moldings from FRP composites are BMC technology (Bulk Molding Compound) and SMC technology (Sheet Molding Compound). In the SMC process, a paste-like composition composed of styrenic polyester resin solution, low-profile additive, crosslinking catalyst, filler, mold-release agent, and also, if appropriate, further additives is prepared, and is applied to a polyamide film. Glass fiber is then scattered onto said layer, and finally a further layer of the paste-like composition is applied. This sheet-like sandwich is then peeled from the foil, cut into pieces, and press-molded to give moldings, using pressure and heat.

In the BMC process, the constituents of the compounding material, the styrenic polyester resin solution, the low-profile additives, the crosslinking catalyst, filler, mold-release agent, and also, if appropriate, further additives, are mixed to give a paste-like composition, and then glass fiber is admixed, and then the molding is produced, using pressure and heat.

Non-functionalized solid polyvinyl acetate resins are currently used as low-profile additives for the BMC process. A disadvantage here is that the addition of fillers which make the mixing specification less expensive is limited by the relatively high intrinsic viscosity of styrenic polyvinyl acetate solutions. For the SMC process, it is known from EP 501176 A1 that the thickening of curable polyester resin molding compositions can be accelerated by addition of thermoplastic vinyl polymers containing acid groups. The use of vinyl acetate acrylic acid copolymers in mixing specifications with thickeners is also described in DE-A 2104575.

It was therefore an object to find a method which permits the incorporation of relatively large amounts of filler into the mixing specification of molding compositions for the BMC process.

Surprisingly, it has been found that use of solid carboxy-functional polyvinyl acetate resins is, for identical molecular weight, styrenic solutions with substantially smaller intrinsic viscosity, thus permitting incorporation of relatively large amounts of filler.

The invention provides the use of solid carboxy-functional polyvinyl acetate resins as additive in formulations without thickener for molding compositions for the production of BMC moldings.

Suitable comonomers having carboxy groups for the production of solid carboxy-functional polyvinyl acetate resins are ethylenically monounsaturated mono- and dicarboxylic acids. Preference is given to acrylic acid, methacrylic acid, fumaric acid, crotonic acid. Crotonic acid is particularly preferred. The proportion of comonomer units having carboxy groups in the solid polyvinyl acetate resin is from 0.5 to 10% by weight, preferably greater than 1% by weight up to 10% by weight, particularly preferably from 3 to 10% by weight, in each case based on the total weight of the solid polyvinyl acetate resin.

The solid carboxy-functional polyvinyl acetate resins are produced in a known manner by the bulk, suspension, or preferably solution polymerization process. Examples of suitable solvents are monohydric, aliphatic alcohols having from 1 to 6 carbon atoms, preferably methanol, ethanol, propanol, isopropanol. Particular preference is given to ethanol and isopropanol. The reaction is generally carried out under reflux conditions, generally at a polymerization temperature of from 40° C. to 140° C., in order to utilize evaporative cooling to dissipate the heat of reaction. This can take place at atmospheric pressure or else at slightly superatmospheric pressure.

Initiators used comprise organic peroxides or azo compounds. Examples of suitable compounds are diacyl peroxides, such as dilauroyl peroxide, peroxo esters, such as tert-butyl peroxopivalate or tert-butyl 2-ethylperoxohexanoate, or peroxodicarbonate, such as diethyl peroxodicarbonate. The amount of initiator is generally from 0.01 to 5.0% by weight, based on the monomers. The initiators can either be used as an initial charge or else can be used as a feed. A method which has proven successful here uses a portion of the required amount of initiator as initial charge and uses the remainder as a continuous feed during the reaction.

The molecular weight can be adjusted in a manner known to the person skilled in the art via polymerization in the presence of molecular weight regulators. Examples of suitable regulators are alcohols, such as ethanol or isopropanol, aldehydes, such as acetaldehyde or propionaldehyde, or silane-containing regulators, such as mercaptosilanes, for example 3-mercaptopropyltrimethoxysilane.

The polymers can be produced by a batch process where all of the components of the polymerization mixture are used as an initial charge in the reactor, or by a semi-batch process where individual components or a plurality of components are used as initial charge and the remainder is/are used as a feed, or polymerization can be carried out continuously, the components being used as a feed during the polymerization process. The feeds can, if appropriate, be separate (spatially and chronologically).

Formulations of FRP composites for BMC technology (Bulk Molding Compound) are known to the person skilled in the art. One typical formulation for unsaturated polyester resin compositions for molding compositions for BMC technology comprises from 60 to 70 parts by weight of unsaturated polyester resin (in the form of solution of strength from 50 to 75% in styrene), from 30 to 40 parts by weight of low-profile additives (in the form of solution of strength from 30 to 50% in styrene), such as polyvinyl acetate or polymethyl methacrylate, from 0.5 to 2 parts by weight of initiator, such as tert-butyl perbenzoate, from 150 to 200 parts by weight of filler, such as calcium carbonate, from 25 to 30 parts by weight of glass fiber, from 0.5 to 3 parts by weight of mold-release agent, such as zinc stearate, and also, if appropriate, further additives, such as pigments and flame-retardant additives. The formulations do not comprise any thickeners, such as basic metal compounds, for example oxide or hydroxides of metals of the 1st to 3rd main group of the periodic table of the elements.

In the use according to the invention, the low-profile additive, preferably based on polyvinyl acetate or polymethyl methacrylate, is replaced entirely or to some extent by carboxy-functional polyvinyl acetate. The amount of the solid carboxylated polyvinyl acetate resin used in the mixing specification is generally from 10 to 100% by weight, preferably from 50 to 80% by weight, in each case based on the total weight of low-profile additive in the mixing specification. It is advantageous here to use said additive in styrenic solution.

The examples below serve for further illustration of the invention:

The viscosities of solid resin solutions in styrene were determined for various solid resins with and without filler:

### Copo1:

Solid polyvinyl acetate resin having 5% by weight of crotonic acid units and with a weight-average molecular weight Mw=67500.

### Homo1:

Solid polyvinyl acetate resin with weight-average molecular weight Mw=69000.

### Homo2:

Solid polyvinyl acetate resin with weight-average molecular weight Mw=116600.

### Copo2:

Solid polyvinyl acetate resin having 5% by weight of crotonic acid units and with a weight-average molecular weight Mw=116750.

### Copo3:

Solid polyvinyl acetate resin having 5% by weight of crotonic acid units and with a weight-average molecular weight Mw=137000.

In each case, a 40% strength by weight solution of the listed polymers was prepared in styrene, and the viscosity of the solution was in each case determined at 23° C. by a Brookfield tester. The test results are given in the table below and in the graphs below as V in ST (viscosity in styrene) in mPas.

In each case 200 parts by weight of the styrenic polymer solutions were then mixed with 300 parts by weight of calcium carbonate (Omyacarb 5GU), and the viscosity of the dispersions was in each case determined at 23° C. by a Brookfield tester. The test results are given in the table below and in the graphs below as V in ST+F (viscosity in styrene with filler) in mPas.

The table and, respectively, the graph shows that admixture of filler to the homopolymers brings about an extreme rise in viscosity, whereas the viscosity rise on addition of filler is very moderate in the case of the copolymers of comparable molecular weight.

| | Copo1 | Homo1 | Homo2 | Copo2 | Copo3 |
|---|---|---|---|---|---|
| V in ST [mPas] | 1030 | 1230 | 2310 | 3090 | 3700 |
| V in ST + F [mPas] | 9850 | 67400 | 71200 | 19000 | 32200 |

1.-6. (canceled)

7. In an unsaturated polyester resin and styrene-containing, thickner-free BMC molding formulation, the improvement comprising:
including at least one solid carboxy-functional polyvinyl acetate resin as an additive where the proportion of comonomer units having carboxy groups in the solid polyvinyl acetate resin is from 3 to 10% by weight, based on the total weight of the solid polyvinyl acetate resin.

8. The formulation of claim 7, where the solid carboxy-functional polyvinyl acetate resins contain comonomer units derived from ethylenically monounsaturated mono- or dicarboxylic acids.

9. The formulation of claim 7, wherein the formulation comprises from 60 to 70 parts by weight of unsaturated polyester resin in the form of a 50 to 75% by weight solution in styrene, from 30 to 40 parts by weight of low-profile additives in the form of a 30 to 50% by weight solution in styrene, from 0.5 to 2 parts by weight of initiator, from 150 to 200 parts by weight of filler, from 25 to 30 parts by weight of glass fiber, and from 0.5 to 3 parts by weight of mold release agent.

10. In the formulation of claim 7, wherein a low profile additive is employed, the improvement comprising replacing from 10 to 100% by weight, based on the weight of low-profile additive in the formulation, with the solid carboxy-functional polyvinyl acetate resin.

11. The formulation of claim 9, where from 50 to 80% by weight, based on the weight of low-profile additive in the formulation, are replaced by the solid carboxy-functional polyvinyl acetate resin.
